(19) United States
(12) Patent Application Publication
(10) Pub. No.: US 2025/0184979 A1
(43) Pub. Date: Jun. 5, 2025

(54) COMMUNICATION CONTROL METHOD

(71) Applicant: KYOCERA Corporation, Kyoto (JP)

(72) Inventor: Mitsutaka HATA, Yokohama-shi (JP)

(73) Assignee: KYOCERA Corporation, Kyoto (JP)

(21) Appl. No.: 19/044,193

(22) Filed: Feb. 3, 2025

Related U.S. Application Data
(63) Continuation of application No. PCT/JP2023/028079, filed on Aug. 1, 2023.
(60) Provisional application No. 63/395,091, filed on Aug. 4, 2022.

(51) Int. Cl. H04W 72/0453; H04W 36/22; H04W 76/27

(52) U.S. Cl. CPC H04W 72/0453; H04W 36/22; H04W 76/27

(57) ABSTRACT

A communication control method according to one aspect is a communication control method in a mobile communication system. The communication control method includes a step of, by a user equipment, ignoring slice specific frequency priority information when receiving an RRC release message from a base station without receiving slice priority information from a core network apparatus, the slice priority information indicating a priority of a network slice, the RRC release message not including legacy frequency priority information and including the slice specific frequency priority information, the legacy frequency priority information indicating a priority per frequency, the slice specific frequency priority information indicating a priority of a frequency supporting the network slice.

### RELATED APPLICATIONS

The present application is a continuation based on PCT Application No. PCT/JP2023/028079, filed on Aug. 1, 2023, which claims the benefit of U.S. Provisional Patent Application No. 63/395,091 filed on Aug. 4, 2022. The content of which is incorporated by reference herein in their entirety.

### TECHNICAL FIELD

The present disclosure relates to a communication control method in a mobile communication system.

### BACKGROUND

Specifications of The Third Generation Partnership Project (3GPP) that is a standardization project for mobile communication systems define Network Slicing. The network slicing is a technique of logically dividing a physical network constructed by a telecommunications carrier to configure network slices that are virtual networks.

A user equipment in a Radio Resource Control (RRC) idle state or an RRC inactive state can perform a cell reselection procedure. The 3GPP has studied slice specific cell reselection (slice aware cell reselection or slice based cell reselection) that is a network slice-dependent cell reselection procedure (see, for example, Non-Patent Document 1). By performing the slice specific cell reselection procedure, the user equipment can camp on, for example, a neighboring cell that supports an intended network slice.

### CITATION LIST

### Non-Patent Literature

Non-Patent Document 1: 3GPP TS 38.300 V 17.8.0 (2022 March)

### SUMMARY

A communication control method according to one aspect is a communication control method in a mobile communication system. The communication control method includes a step of, by a user equipment, ignoring slice specific frequency priority information when the user equipment receives an RRC release message from a base station without receiving slice priority information from a core network apparatus, the slice priority information indicating a priority of a network slice, the RRC release message not including legacy frequency priority information and including the slice specific frequency priority information, the legacy frequency priority information indicating a priority per frequency, the slice specific frequency priority information indicating a priority of a frequency supporting the network slice.

### BRIEF DESCRIPTION OF THE DRAWINGS

FIG. 1 is a diagram illustrating a configuration example of a mobile communication system according to a first embodiment.

FIG. 2 is a diagram illustrating a configuration example of a user equipment (UE) according to the first embodiment.

FIG. 3 is a diagram illustrating a configuration example of a gNB (base station) according to the first embodiment.

FIG. 4 is a diagram illustrating a configuration example of a protocol stack for a user plane according to the first embodiment.

FIG. 5 is a diagram illustrating a configuration example of a protocol stack for a control plane according to the first embodiment.

FIG. 6 is a diagram for explaining an overview of a cell reselection procedure.

FIG. 7 is a diagram illustrating a schematic flowchart of a typical cell reselection procedure.

FIG. 8 is a diagram illustrating an example of network slicing.

FIG. 9 is a diagram illustrating an overview of a slice specific cell reselection procedure.

FIG. 10 is a diagram illustrating an example of slice frequency information.

FIG. 11 is a diagram illustrating a basic flowchart of the slice specific cell reselection procedure.

FIG. 12 is a diagram illustrating an operation example according to the first embodiment.

FIG. 13 is a diagram illustrating signaling mismatch between an AMF and a gNB.

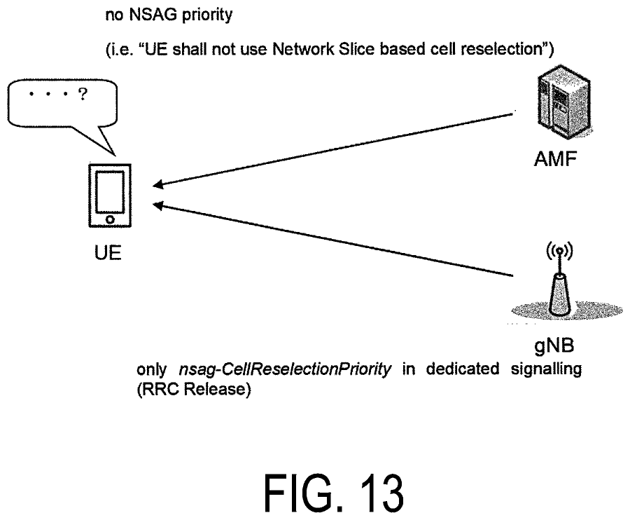

### DESCRIPTION OF EMBODIMENTS

A mobile communication system according to an embodiment will be described with reference to the drawings. In the description of the drawings, the same or similar parts are denoted by the same or similar reference signs.

### First Embodiment

### Configuration of Mobile Communication System

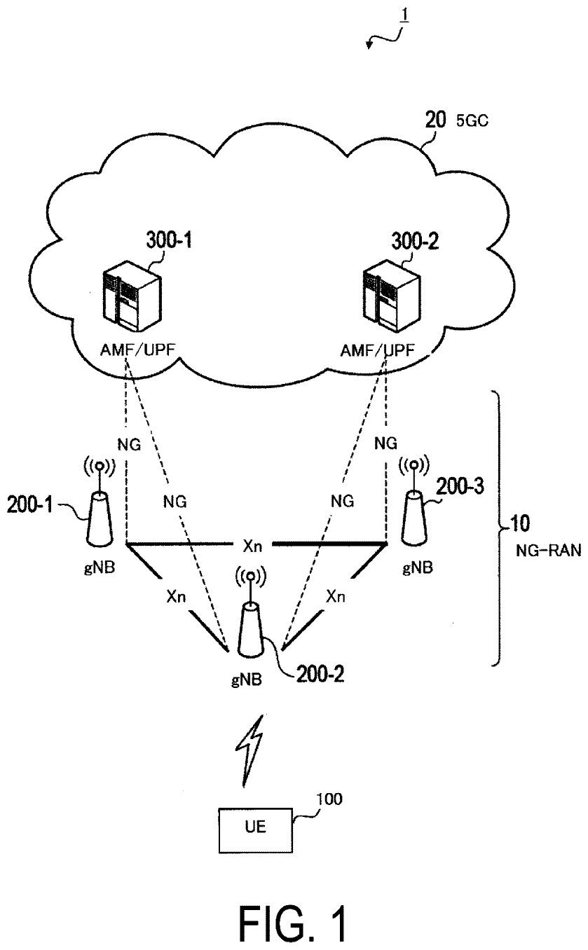

FIG. 1 is a diagram illustrating a configuration of a mobile communication system according to a first embodiment. A mobile communication system 1 complies with the 5th Generation System (5GS) of the 3GPP standards. The description below takes the 5GS as an example, but Long Term Evolution (LTE) system may be at least partially applied to the mobile communication system. The 6th generation (6G) system may be applied at least in part.

The mobile communication system 1 includes a User Equipment (UE) 100, a 5G radio access network (Next Generation Radio Access Network (NG-RAN)) 10, and a 5G Core Network (5GC) 20. The NG-RAN 10 will be hereinafter simply referred to as a RAN 10. The 5GC 20 may be simply referred to as a core network (CN) 20.

The UE 100 is a mobile wireless communication apparatus. The UE 100 may be any apparatus as long as the UE 100 is used by a user. Examples of the UE 100 include a mobile phone terminal (including a smartphone) and/or a tablet terminal, a notebook PC, a communication module (including a communication card or a chipset), a sensor or a device provided on a sensor, a vehicle or a device provided on a vehicle (Vehicle UE), and a flying object or a device provided on a flying object (Aerial UE).

The NG-RAN 10 includes base stations (referred to as “gNBs” in the 5G system) 200. The gNBs 200 are interconnected via an Xn interface that is an inter-base station interface. Each gNB 200 manages one or more cells. The gNB 200 performs wireless communication with the UE 100 that has established connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as a “frequency”).

Note that the gNB 200 can be also connected to an Evolved Packet Core (EPC) corresponding to an LTE core network. An LTE base station can be also connected to the 5GC 20. The LTE base station and the gNB 200 can be also connected via an inter-base station interface.

The 5GC 20 includes an Access and Mobility Management Function (AMF) and a User Plane Function (UPF) 300. The AMF performs various types of mobility control and the like on the UE 100. The AMF manages mobility of the UE 100 by communicating with the UE 100 by using Non-Access Stratum (NAS) signaling. The UPF controls data transfer. The AMF and UPF are connected to the gNB 200 via an NG interface that is an interface between the base station and the core network.

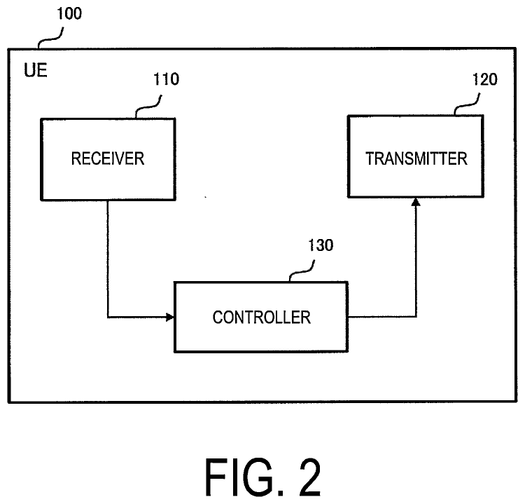

FIG. 2 is a diagram illustrating a configuration of the user equipment (UE) 100 according to the first embodiment. The UE 100 includes a receiver 110, a transmitter 120, and a controller 130. The receiver 110 and the transmitter 120 constitute a wireless communicator that performs wireless communication with the gNB 200.

The receiver 110 performs various types of reception under control of the controller 130. The receiver 110 includes an antenna and a reception device. The reception device converts a radio signal received through the antenna into a baseband signal (reception signal) and outputs the baseband signal to the controller 130.

The transmitter 120 performs various types of transmission under control of the controller 130. The transmitter 120 includes an antenna and a transmission device. The transmission device converts a baseband signal (transmission signal) output by the controller 130 into a radio signal and transmits the radio signal through the antenna.

The controller 130 performs various types of control and processing in the UE 100. Such processing includes processing of respective layers to be described below. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to perform various types of processing. Note that the controller 130 may perform each processing and each operation in the UE 100 in each embodiment to be described below.

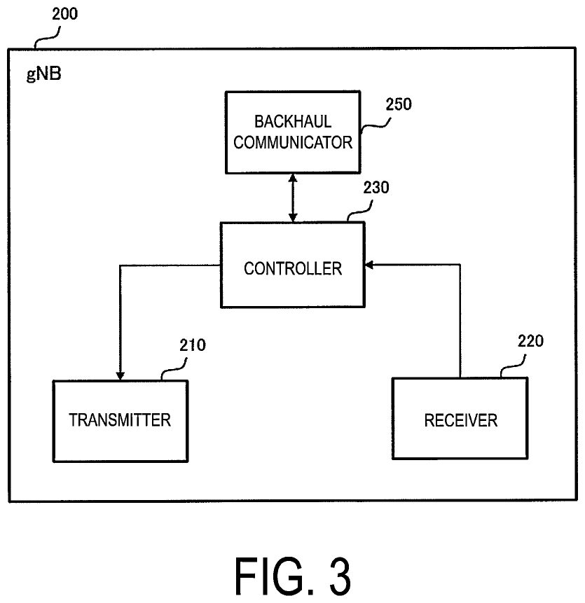

FIG. 3 is a diagram illustrating a configuration of the gNB 200 (base station) according to the first embodiment. The gNB 200 includes a transmitter 210, a receiver 220, a controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various types of transmission under control of the controller 230. The transmitter 210 includes an antenna and a transmission device. The transmission device converts a baseband signal (transmission signal) output by the controller 230 into a radio signal and transmits the radio signal through the antenna.

The receiver 220 performs various types of reception under control of the controller 230. The receiver 220 includes an antenna and a reception device. The reception device converts a radio signal received through the antenna into a baseband signal (reception signal) and outputs the baseband signal to the controller 230.

The controller 230 performs various types of control and processing in the gNB 200. Such processing includes processing of respective layers to be described below. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to perform various types of processing. Note that the controller 230 may perform each processing and each operation in the gNB 200 in each embodiment to be described below.

The backhaul communicator 240 is connected to a neighboring base station via an Xn interface that is an inter-base station interface. The backhaul communicator 240 is connected to the AMF/UPF 300 via an NG interface that is an interface between the base station and the core network. Note that the gNB 200 may include a Central Unit (CU) and a Distributed Unit (DU) (i.e., functions are divided), and the both units may be connected via an F1 interface that is a fronthaul interface.

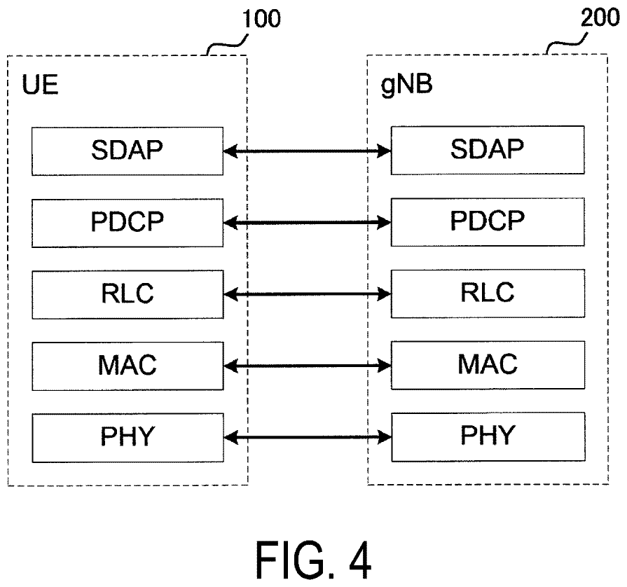

FIG. 4 is a diagram illustrating a configuration of a protocol stack of a radio interface of a user plane handling data.

A radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). More specifically, the UE 100 blind decodes the PDCCH using a radio network temporary identifier (RNTI) and acquires successfully decoded DCI as DCI addressed to the UE 100. The DCI transmitted from the gNB 200 is appended with CRC parity bits scrambled by the RNTI.

The MAC layer performs priority control of data, retransmission processing through Hybrid Automatic Repeat reQuest (Hybrid ARQ (HARQ)), a random access procedure, and the like. Data and control information are transmitted between the MAC layer of the UE 100 and the MAC layer of the gNB 200 via a transport channel. The MAC layer of the gNB 200 includes a scheduler. The scheduler determines transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as a unit of Quality of Service (QoS) control performed by the core network and a radio bearer as a unit of QoS control performed by an Access Stratum (AS). Note that, when the RAN is connected to the EPC, the SDAP need not be provided.

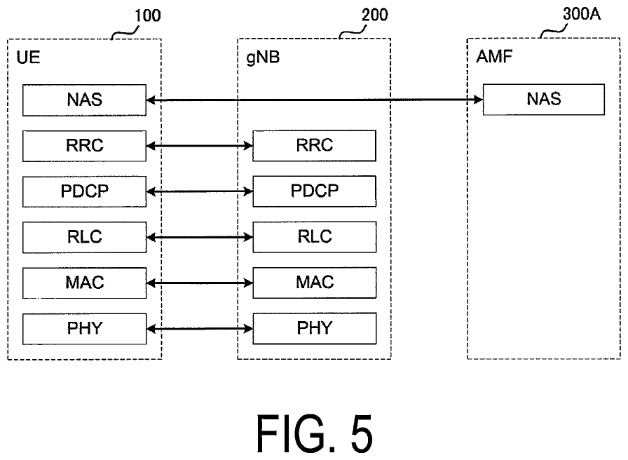

FIG. 5 is a diagram illustrating a configuration of a protocol stack of a radio interface of a control plane handling signaling (control signal).

The protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) is made between the RRC of the UE 100 and the RRC of the gNB 200, the UE 100 is in an RRC connected state. When no connection (RRC connection) is made between the RRC of the UE 100 and the RRC of the gNB 200, the UE 100 is in an RRC idle state. When the connection between the RRC of the UE 100 and the RRC of the gNB 200 is suspended, the UE 100 is in an RRC inactive state.

The NAS that is positioned upper than the RRC layer performs session management, mobility management, and the like. NAS signaling is transmitted between the NAS of the UE 100 and the NAS of the AMF 300. Note that the UE 100 includes an application layer, in addition to the protocols of the radio interface. A layer lower than the NAS is referred to as an Access Stratum (AS).

### Overview of Cell Reselection Procedure

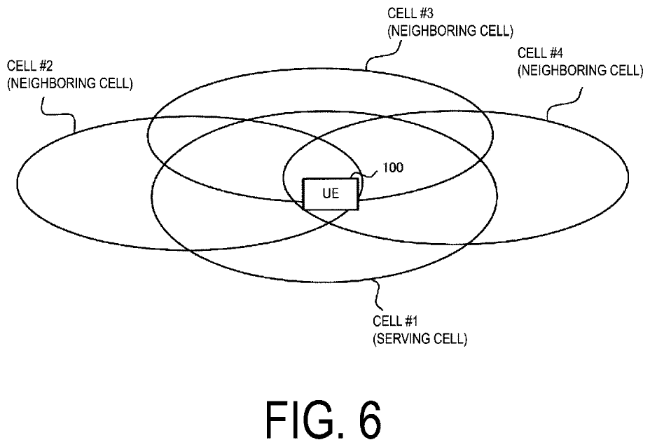

FIG. 6 is a diagram for explaining an overview of a cell reselection procedure.

The UE 100 in the RRC idle state or the RRC inactive state performs the cell reselection procedure to migrate from a current serving cell (cell #1) to a neighboring cell (any one of cells #2 to #4) as the UE 100 moves. More specifically, the UE 100 specifies a neighboring cell on which the UE is to camp through the cell reselection procedure, and reselects the specified neighboring cell. Frequencies (carrier frequencies) that are the same between the current serving cell and the neighboring cell will be referred to as intra-frequencies, and frequencies (carrier frequencies) that are different between the current serving cell and the neighboring cell will be referred to as inter-frequencies. The current serving cell and the neighboring cell may be managed by the same gNB 200. The current serving cell and the neighboring cell may be managed by the gNBs 200 different from each other.

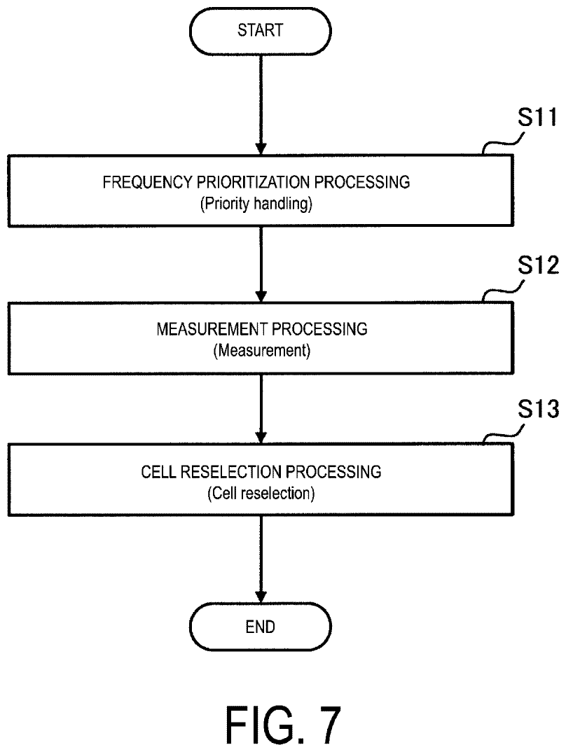

FIG. 7 is a diagram illustrating a schematic flowchart of a typical (or legacy) cell reselection procedure.

In step S11, the UE 100 performs frequency prioritization processing based on a priority per frequency (also referred to as an “absolute priority”) specified by the gNB 200 by way of, for example, an RRC release message. More specifically, the UE 100 manages the frequency priority designated by the gNB 200 per frequency.

In step S12, the UE 100 performs measurement processing of measuring radio qualities of the serving cell and each of the neighboring cells. The UE 100 measures reception powers and reception qualities of reference signals transmitted by the serving cell and each of the neighboring cells, more specifically, a Cell Defining-Synchronization Signal and PBCH block (CD-SSB). For example, the UE 100 always measures the radio qualities of frequencies having higher priorities than the priority of the frequency of the current serving cell, and, when the radio quality of the current serving cell is below a predetermined quality, measures the radio qualities of frequencies having priorities equal to or lower than the priority of the frequency of the current serving cell.

In step S13, the UE 100 performs cell reselection processing of reselecting a cell on which the UE 100 is to camp based on the measurement result in step S12. For example, when the priority of the frequency of a neighboring cell is higher than the priority of the frequency of the current serving cell and the neighboring cell satisfies a predetermined quality standard (i.e., minimal required quality standard) for a predetermined period of time, the UE 100 may perform cell reselection for the neighboring cell. When the frequency priorities of neighboring cells are the same as the priority of the current serving cell, the UE 100 may rank the radio qualities of the neighboring cells to perform cell reselection for a neighboring cell ranked higher than the ranking of the current serving cell for a predetermined period of time. When the priority of the frequency of a neighboring cell is lower than the priority of the current serving cell, the radio quality of the current serving cell is lower than a certain threshold, and the radio quality of the neighboring cell is continuously higher than another threshold for a predetermined period of time, the UE 100 may perform cell reselection for the neighboring cell.

### Overview of Network Slicing

Network slicing is a technique of virtually dividing a physical network (e.g., a network including the NG-RAN 10 and the 5GC 20) constructed by a telecommunications carrier to create a plurality of virtual networks. Each virtual network is referred to as a “network slice”. Hereinafter, the network slice will be also simply referred to as a “slice”.

The network slicing allows a telecommunications carrier to create slices conforming to service requirements of different service types, such as enhanced Mobile Broadband (eMBB), Ultra-Reliable and Low Latency Communications (URLLC), and massive Machine Type Communications (mMTC), for example, to optimize network resources.

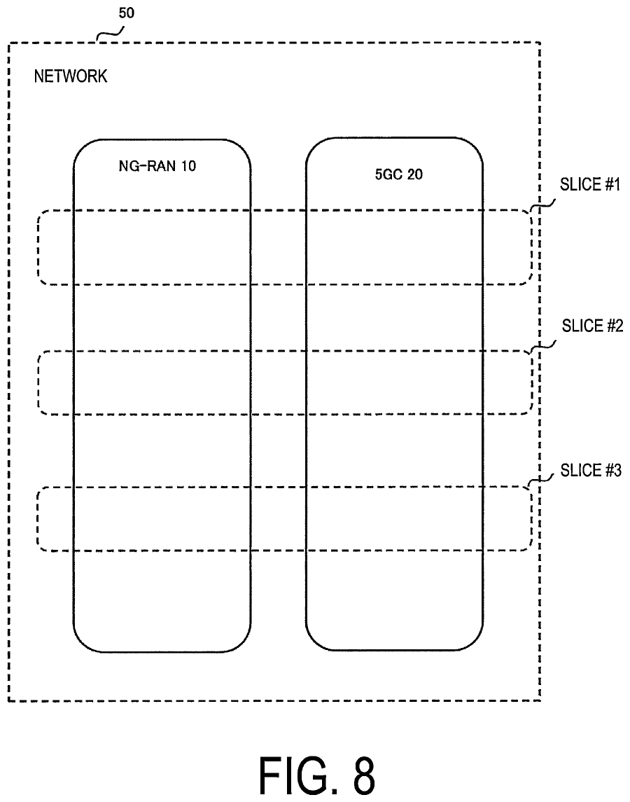

FIG. 8 is a diagram illustrating an example of network slicing.

Three slices (slices #1 to #3) are configured on a network 50 including the NG-RAN 10 and the 5GC 20. The slice #1 is associated with the service type called eMBB, the slice #2 is associated with the service type called URLLC, and the slice #3 is associated with the service type called mMTC. Note that three or more slices may be configured on the network 50. One service type may be associated with a plurality slices.

Each slice is provided with a slice identifier for identifying the slice. Examples of the slice identifier include Single Network Slicing Selection Assistance Information (S-NSSAI). The S-NSSAI includes an 8-bit slice/service type (SST). The S-NSSAI may further include a 24-bit slice differentiator (SD). The SST is information indicating a service type with which a slice is associated. The SD is information for differentiating a plurality of slices associated with the same service type. Information including a plurality of pieces of S-NSSAI is referred to as Network Slice Selection Assistance Information (NSSAI).

One or more slices may be grouped to configure a slice group. The slice group is a group including one or more slices, and a slice group identifier is assigned to the slice group. The slice group may be configured by the core network (e.g., AMF 300), or may be configured by the radio access network (e.g., gNB 200). The UE 100 may be notified of the configured slice group.

Hereinafter, the term “network slice (slice)” may refer to S-NSSAI that is an identifier of a single slice or NSSAI that is a collection of pieces of S-NSSAI. The term “network slice (slice)” may refer to a slice group that is a group of one or more pieces of S-NSSAI or NSSAI. The slice group may be represented by NSSAI. The slice group may be represented by a Network Slice Access Stratum Group (NSAG).

The UE 100 determines a desired slice that the UE 100 desires to use. The desired slice may be referred to as an “Intended slice”. In the first embodiment, the UE 100 determines a slice priority per network slice (desired slice). For example, the NAS of the UE 100 determines the slice priority based on an operation status of an application in the UE 100, a user operation/configuration, and/or the like, and notifies the AS of slice priority information indicating the determined slice priority. Note that the NAS of the UE 100 receives the slice priority information from the AMF 300. That is, the AMF 300 determines the slice priority per slice. The AMF 300 transmits the slice priority information indicating the slice priority to the NAS of the UE 100. The NAS of the UE 100 may determine the slice priority based on the slice priority information received from the AMF 300.

### Overview of Slice Specific Cell Reselection Procedure

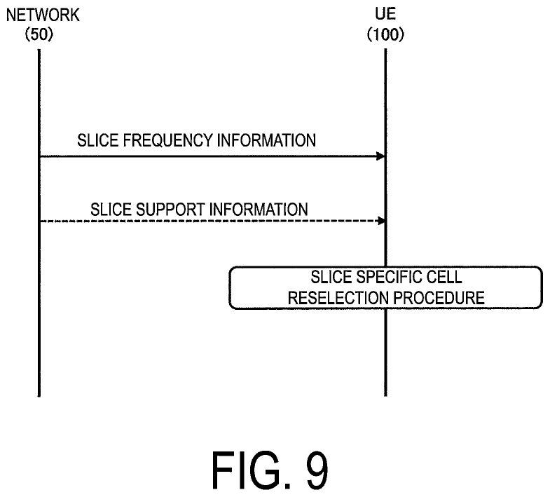

FIG. 9 is a diagram illustrating an overview of a slice-specific cell reselection (slice aware cell reselection or slice based cell reselection) procedure.

In the slice specific cell reselection procedure, the UE 100 performs cell reselection processing based on slice frequency information provided from the network 50. The slice frequency information may be provided from the gNB 200 to the UE 100 through dedicated signaling (e.g., RRC release message).

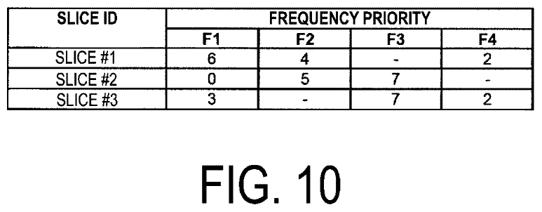

The slice frequency information is information indicating mapping between network slices, frequencies, and frequency priorities. For example, the slice frequency information indicates, for each slice (or slice group), a frequency (one or more frequencies) that supports the slice and a frequency priority assigned to each frequency. FIG. 10 illustrates an example of the slice frequency information.

In the example illustrated in FIG. 10, three frequencies F1, F2, and F4 are associated with the slice #1 as frequencies that support the slice #1. Among these three frequencies, the frequency priority of F1 is “6”, the frequency priority of F2 is “4”, and the frequency priority of F4 is “2”. In the example in FIG. 10, although the priority is assumed to be higher as a numeral of a frequency priority becomes greater, the priority may be higher as a numeral of a frequency priority becomes smaller.

Three frequencies F1, F2, and F3 are associated with the slice #2 as frequencies that support the slice #2. Among these three frequencies, the frequency priority of F1 is “0”, the frequency priority of F2 is “5”, and the frequency priority of F3 is “7”.

The three frequencies F1, F3, and F4 are associated with the slice #3 as frequencies that support the slice #3. Among these three frequencies, the frequency priority of F1 is “3”, the frequency priority of F3 is “7”, and the frequency priority of F4 is “2”.

Hereinafter, the frequency priority indicated in the slice frequency information may be referred to as a “slice specific frequency priority” in order to be distinguished from an absolute priority in a cell reselection procedure of related art.

As illustrated in FIG. 9, the UE 100 may perform cell reselection processing based on slice support information provided from the network 50. The slice support information may be information indicating mapping between cells (e.g., a serving cell and each neighboring cell) and network slices that are not provided or provided by the cells. For example, a cell may not temporarily provide some or all network slices for a reason of congestion or the like. That is, even for a slice support frequency capable of providing a network slice, some cells in the frequency may not provide the network slice. Based on the slice support information, the UE 100 can recognize a network slice not provided by each cell. Such slice support information may be provided from the gNB 200 to the UE 100 through broadcast signaling (e.g., system information block) or dedicated signaling (e.g., RRC release message).

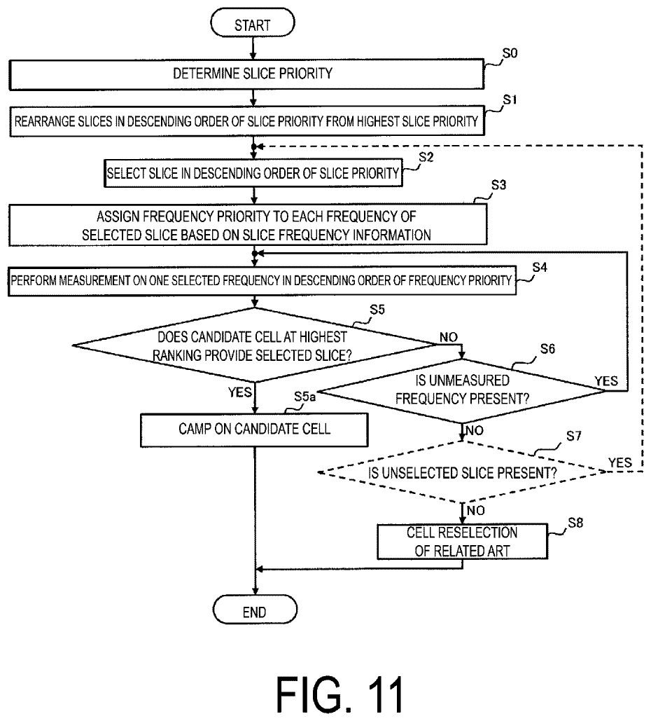

FIG. 11 is a diagram illustrating a basic flowchart of the slice specific cell reselection procedure. It is assumed that, before starting the slice specific cell reselection procedure, the UE 100 is in the RRC idle state or the RRC inactive state, and receives and retains the above-mentioned slice frequency information. Note that a procedure of the “slice specific cell reselection” indicates the “slice specific cell reselection procedure”. In this regard, in the following, “slice specific cell reselection” and “slice specific cell reselection procedure” may be used in the same sense.

In step S0, the NAS of the UE 100 determines the slice identifiers of desired slices for the UE 100 and the slice priorities of the respective desired slices, and notifies the AS of the UE 100 of slice priority information including the determined slice priorities. The “desired slices” are “Intended slices”, and include a slice that is likely to be used, a candidate slice, a desired slice, a slice with which communication is desired, a requested slice, an allowed slice, or a planned slice. For example, the slice priority of the slice #1 is determined to be “3”, the slice priority of the slice #2 is determined to be “2”, and the slice priority of the slice #3 is determined to be “1”. Although the priority is assumed to be higher as a numeral of a slice priority becomes greater, the priority may be higher as a numeral of a slice priority becomes smaller.

In step S1, the AS of the UE 100 rearranges the slices (slice identifiers) notified by the NAS in step S0, in descending order of slice priority. A list of the slices arranged in this manner will be referred to as a “slice list”.

In step S2, the AS of the UE 100 selects one network slice in descending order of slice priority. The network slice selected in this manner is referred to as a “selected network slice”.

In step S3, the AS of the UE 100 assigns a frequency priority to each frequency associated with the selected network slice. More specifically, the AS of the UE 100 specifies frequencies associated with the slice and assigns frequency priorities to the specified frequencies based on the slice frequency information. For example, when the selected network slice selected in step S2 is the slice #1, the AS of the UE 100 assigns the frequency priority “6” to the frequency F1, the frequency priority “4” to the frequency F2, and the frequency priority “2” to the frequency F4 based on the slice frequency information (e.g., information in FIG. 10). The AS of the UE 100 refers to a list of the frequencies arranged in descending order of frequency priority as a “frequency list”.

In step S4, the AS of the UE 100 selects, in descending order of frequency priority, one of the frequencies of the selected network slice selected in step S2, and performs measurement processing on the selected frequency. The frequency selected in this manner is referred to as a “selected frequency”. The AS of the UE 100 may rank cells measured within the selected frequency in descending order of radio quality. Among the cells measured within the selected frequency, a cell satisfying a predetermined quality standard (i.e., minimal required quality standard) will be referred to as a “candidate cell”.

In step S5, the AS of the UE 100 specifies a cell at the highest rank based on results of the measurement processing in step S4, and determines whether the cell provides the selected network slice based on the slice support information. When determining that the cell at the highest rank provides the selected network slice (step S5: YES), the AS of the UE 100 reselects the cell at the highest rank and camps on that cell in step S5a.

On the other hand, when determining that the cell at the highest rank does not provide the selected network slice (step S5: NO), the AS of UE 100 determines in step S6 whether a frequency that is not yet measured is present on the frequency list created in step S3. In other words, the AS of the UE 100 determines whether a frequency assigned in step S3 other than the selected frequency is present in the selected network slice. When determining that a frequency that is not yet measured is present (step S6: YES), the AS of the UE 100 resumes the processing for the frequency ranked at the next highest frequency priority, and performs the measurement processing using that frequency as a selected frequency (returns to the processing of step S4).

When determining that a frequency that is not yet measured is not present on the frequency list created in step S3 (step S6: NO), the AS of the UE 100 may determine in step S7 whether an unselected slice is present on the slice list created in step S1. In other words, the AS of the UE 100 may determine whether a network slice other than the selected network slice is present on the slice list. When determining that an unselected slice is present (step S7: YES), the AS of the UE 100 resumes the processing for the network slice ranked at the next highest slice priority, and selects that network slice as a selected network slice (returns to the processing of step S2). Note that, in the basic flowchart indicated in FIG. 11, the processing in step S7 may be omitted.

When determining that an unselected slice is not present (step S7: NO), the AS of the UE 100 performs cell reselection processing of related art in step S8. The cell reselection processing of related art may mean an entirety of the typical (or legacy) cell reselection procedure illustrated in FIG. 7. The cell reselection processing of related art may also mean only cell reselection processing (step S13) illustrated in FIG. 7. In the latter case, the UE 100 may use the measurement result in step S4 without measuring the radio qualities of the cells again.

### Communication Control Method According to First Embodiment

In the 3GPP, there are agreements about the following specifications regarding a frequency priority (hereinafter referred to as a “legacy frequency priority”) used in a legacy cell reselection procedure (FIG. 7) and a frequency priority (hereinafter referred to as a “slice specific frequency priority”) used in a slice specific cell reselection procedure (FIG. 11).
(1) An RRC release (RRCRelease) message can include the legacy frequency priority and/or the slice specific frequency priority.
(2) When an RRC release message includes one of these frequency priorities, the UE 100 ignores all frequency priorities (legacy frequency priority and/or slice specific frequency priority) received by way of system information (SIB).
(3) When not receiving a slice priority from the AMF 300, the UE 100 cannot perform a slice specific cell reselection procedure.

For example, a case is assumed in which the UE 100 does not receive a slice priority from the AMF 300 when receiving, from the gNB 200, an RRC release message that does not include a legacy frequency priority and that includes a slice specific frequency priority. In such a case, since the UE 100 does not receive the slice priority from the AMF 300 in spite of the fact that the UE 100 has received the slice specific frequency priority from the gNB 200, the UE 100 cannot perform a slice specific cell reselection procedure because of (3) described above.

In this way, although there are agreements about the specifications according to (1) to (3) above, because of a case as described above, the UE 100 may not be able to appropriately perform a cell reselection procedure.

Thus, an object of the first embodiment is to enable the UE 100 to appropriately perform a cell reselection procedure.

Note that a cell reselection procedure not using a network slice may be referred to as a “legacy cell reselection procedure” below. FIG. 7 illustrates an example of the legacy cell reselection procedure. On the other hand, a cell reselection procedure using a network slice may be referred to as a “slice specific cell reselection procedure”. FIG. 11 illustrates an example of the slice specific cell reselection procedure. When the legacy cell reselection procedure and the slice specific cell reselection procedure are not particularly distinguished from each other, each procedure may be simply referred to as a “cell reselection procedure”.

In the following description, a priority per frequency used in the legacy cell reselection procedure (which may be referred to as an “absolute priority”) may be referred to as a “legacy frequency priority” as described above. “Legacy frequency priority information” indicating the legacy frequency priority is included in an RRC release message and/or SIB and transmitted from the gNB 200 to the UE 100.

On the other hand, a priority per network slice may be referred to as a “slice priority”. The slice priority is used in the slice specific cell reselection procedure. “Slice priority information” indicating the slice priority is included in a NAS message and transmitted from the AMF 300 to the UE 100.

A priority per frequency supporting the network slice may be referred to as a “slice specific frequency priority” as described above. The slice specific frequency priority is also used in the slice specific cell reselection procedure. “Slice specific frequency priority information” indicating the slice specific frequency priority is included in an RRC release message and/or SIB and transmitted from the gNB 200 to the UE 100. Note that the slice specific frequency priority information includes the above slice frequency information. Alternatively, the slice specific frequency priority information may be the slice frequency information.

When the legacy frequency priority and the slice specific frequency priority are not particularly distinguished from each other, each priority may be simply referred to as a “frequency priority”.

As described above, a slice may refer to a single slice. The slice may refer to a slice group including a plurality of slices. The slice may refer to a plurality of slice groups. The slice group may be represented by an NSAG.

In the first embodiment, an example will be described in which, when receiving an RRC release message including a slice specific frequency priority without receiving slice priority information, the UE 100 ignores the slice specific frequency priority.

More specifically, when the user equipment (e.g., UE 100) receives, from the base station (e.g., gNB 200), an RRC release message that does not include legacy frequency priority information indicating a priority per frequency and that includes slice specific frequency priority information indicating a priority of a frequency supporting a network slice without receiving, from the core network apparatus (e.g., AMF 300), slice priority information indicating a priority of the network slice, the user equipment ignores the slice specific frequency priority information.

Accordingly, for example, when the UE 100 receives an RRC release message that does not include a legacy frequency priority and that includes a slice specific frequency priority in spite of the fact that the UE 100 has not received a slice priority from the AMF 300, a countermeasure for the UE 100 (ignoring of the slice specific frequency priority) can be taken.

In this case, the UE 100 ignores the slice specific frequency priority information included in the RRC release message and thus does not perform a slice specific cell reselection procedure using the slice specific frequency priority information. This is also consistent with the agreement of the 3GPP that a slice specific cell reselection procedure shall not be used when the UE 100 does not receive a slice priority.

When receiving a system information block (SIB) including legacy frequency priority information from the gNB 200, the UE 100 performs a legacy cell reselection procedure using the legacy frequency priority information.

Consequently, the UE 100 can appropriately perform the cell reselection procedure.

### Operation Example According to First Embodiment

An operation example according to the first embodiment will be described.

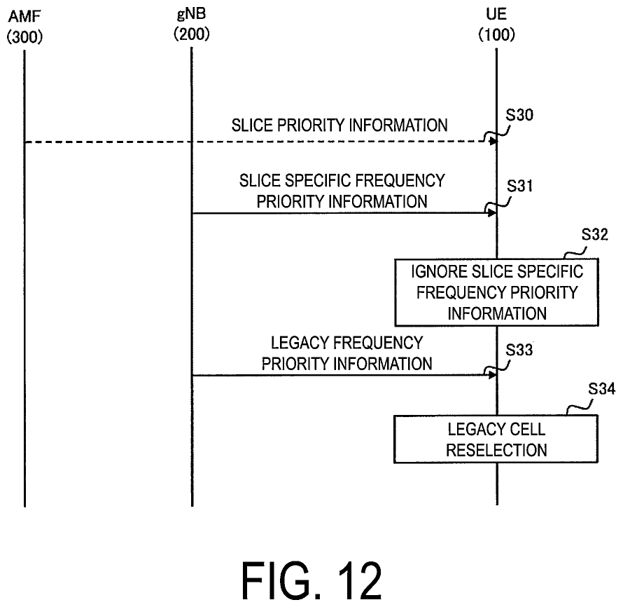

FIG. 12 is a diagram illustrating the operation example according to the first embodiment.

As illustrated in FIG. 12, in step S30, the AMF 300 does not transmit slice priority information to the UE 100. Thus, the UE 100 does not receive the slice priority information.

In step S31, the gNB 200 transmits an RRC release message that does not include legacy frequency priority information and that includes slice specific frequency priority information. The UE 100 receives the RRC release message.

In step S32, the UE 100 ignores the slice specific frequency priority information included in the RRC release message. Note that the AMF 300 may transmit, to the UE 100, an NAS message including information for instructing the UE 100 to perform an operation for the ignoring. The UE 100 may perform the operation for the ignoring in response to reception of the NAS message. Alternatively, the gNB 200 may transmit, to the UE 100, an RRC message (such as an SIB or an RRC release (RRCRelease) message) including information for instructing the UE 100 to perform an operation for the ignoring. The UE 100 may perform the operation for the ignoring in response to reception of the RRC message. Alternatively, performing the operation for the ignoring may be hard-coded within the UE 100. The UE 100 may transmit, to the gNB 200, an RRC message including information indicating that the slice specific frequency priority information has been ignored.

In step S33, the gNB 200 broadcasts a system information block (SIB) including legacy frequency priority information. The UE 100 receives the SIB.

In step S34, the UE 100 performs a legacy cell reselection procedure using the legacy frequency priority information included in the SIB. Note that even when the UE 100 receives the SIB before a T320 timer, which is a period indicating that the information included in the RRC release message is valid, expires, the UE 100 performs the legacy cell reselection procedure using the legacy frequency priority information included in the SIB.

### Other Embodiments

A program causing a computer to execute each of the processing performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Circuits for executing processing performed by the UE 100 or the gNB 200 may be integrated, and at least a part of the UE 100 and the gNB 200 may be implemented as a semiconductor integrated circuit (chipset, System on a chip (SoC)).

The phrases “based on” and “depending on” used in the present disclosure do not mean “based only on” and “only depending on”, unless specifically stated otherwise. The phrase “based on” means both “based only on” and “based at least in part on”. Similarly, the phrase “depending on” means both “only depending on” and “at least partially depending on”. The terms “include”, “comprise” and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

The embodiments have been described above in detail with reference to the drawings, but specific configurations are not limited to those described above, and various design variations can be made without departing from the gist of the present disclosure. All or some of the embodiments, operations, processes, and steps may be combined without being inconsistent.

### First Supplementary Note

Features related to the above-described embodiment will be supplementarily described.

### Supplementary Note 1

A communication control method in a mobile communication system, the communication control method including, by a user equipment, ignoring slice specific frequency priority information when the user equipment receives an RRC release message from a base station without receiving slice priority information from a core network apparatus, the slice priority information indicating a priority of a network slice, the RRC release message not including legacy frequency priority information and including the slice specific frequency priority information, the legacy frequency priority information indicating a priority per frequency, the slice specific frequency priority information indicating a priority of a frequency supporting the network slice.

### Supplementary Note 2

The communication control method according to Supplementary Note 1, wherein the ignoring includes, by the user equipment, performing a legacy cell reselection procedure by using the legacy frequency priority information when the user equipment receives, from the base station, a system information block including the legacy frequency priority information.

### Supplementary Note 3

The communication control method according to Supplementary Note 1 or 2, further including, by the user equipment to the base station, transmitting an RRC message including information indicating that the slice specific frequency priority information has been ignored.

### Second Supplementary Note

### 1. Introduction

Based on the meeting in RAN2 #118e, the following agreements for slice specific cell reselection were reached.

When an RRC release message includes some kind of cell reselection priority, a UE needs to consider only the cell reselection priority received in the RRC release and ignore all kinds of cell reselection priorities received in an SIB message.

The RRC release can include both legacy and slice specific reselection priorities.

We have found that there is a problem between these agreements and the SA2 specifications. In the supplementary note, the problem will be discussed.

### 2. Discussion

### 2.1 Definition of Problem

The previous agreements in RAN2 have been defined as follows, which are indicated in TS38.304.

### 5.2.4 Cell Reselection Evaluation Process

### 5.2.4.1 Reselection Priorities Handling

Absolute priorities of different NR frequencies or inter-RAT frequencies may be provided to the UE in the system information, in the RRC release message, or by inheriting from another RAT at inter-RAT cell (re) selection. In the case of system information, an NR frequency or inter-RAT frequency may be listed without providing a priority (i.e. no cellReselectionPriority field is present for that frequency). If any fields with cellReselectionPriority or nsag-CellReselectionPriority are provided in dedicated signaling, the UE shall ignore any fields with cellReselectionPriority and nsag-CellReselectionPriority provided in system information.

Based on the above specifications, the following observations will be made.

Observation 1: When receiving the dedicated priority in the SIB, the UE shall ignore the frequency priority.

On the other hand, TS23.501 has the following SA2 specifications.

### 5.3.4.3.4 Network Slice Based Cell Reselection

When one or more S-NSSAI(s) are associated with NSAG(s), the UE may perform Network Slice based cell reselection as described in TS 38.300, TS 38.304, TS 38.331, and TS 24.501.

When providing NSAG Information to the UE, the AMF shall also provide the NSAG priority information for the NSAGs provided in the NSAG Information. The AMF determines the NSAG priority information based on the operator's policy. If the UE has received NSAG priority information from the AMF, the UE shall use the NSAG priority information provided by the AMF for cell reselection as described below. If the UE has not received any NSAG priority information from the AMF, the UE shall not use Network Slice based cell reselection at all.

Based on the above specifications, the following observations will be made.

Observation 2: The UE does not perform the slice specific cell reselection when not receiving the NSAG priority from the AMF.

There is a discrepancy between these specifications. That is, when the UE does not receive the NSAG priority from the AMF and dedicated signaling (such as RRC release) includes only nsag-CellReselectionPriority, the UE shall ignore the cell reselection priority provided in the system information and cannot use nsag-CellReselectionPriority included in the dedicated signaling, so that the UE cannot perform the cell reselection by applying a given cell reselection priority. Thus, RAN2 should define a solution to this problem.

Proposal 1: RAN2 should define a solution to this problem. That is, when the UE does not receive the NSAG priority information from the AMF and the dedicated signaling includes only nsag-CellReselectionPriority, the UE cannot perform the cell reselection by applying a given cell reselection priority.

The solution is divided into handling on the gNB side and handling on the UE side.

### 2.1.1 Handling on gNB Side

2.1.1.1. The gNB always configures both cellReselectionPriority and nsag-CellReselectionPriority in the dedicated signaling when nsag-CellReselectionPriority is configured.

The simplest method is a solution where the gNB always configures both cellReselectionPriority and nsag-CellReselectionPriority in the dedicated signaling when nsag-CellReselectionPriority is configured.

Thus, even when the UE does receive the NSAG priority from the AMF, cellReselectionPriority can be applied. However, when the UE receives the NSAG priority from the AMF, this solution may be wasteful.

Observation 3: As handling on the gNB side, there is a solution where the gNB always configures both cellReselectionPriority and nsag-CellReselectionPriority in the dedicated signaling when nsag-CellReselectionPriority is configured.

2.1.1.2. When the UE does not receive the NSAG priority from the AMF, the gNB configures cellReselectionPriority in the dedicated signaling.

On the other hand, there is also a solution where the gNB configures cellReselectionPriority in the dedicated signaling when the UE does not receive the NSAG priority from the AMF. However, in the case of this solution, the gNB needs to check in advance whether the UE has received the NSAG priority from the AMF. Thus, there is a need for a signal, from the AMF to the gNB or from the UE to the gNB, which indicates that the UE has received the NSAG priority from the AMF.

Observation 4: As handling on the gNB side, there is a solution where the gNB configures cellReselectionPriority in the dedicated signaling when the UE does not receive the NSAG priority from the AMF. In this solution, since the gNB needs to check in advance whether the UE has received the NSAG priority from the AMF, there is a need for a signal, from the AMF to the gNB or from the UE to the gNB, which indicates that the UE has received the NSAG priority from the AMF.

### 2.1.2. Handling on UE Side

As handling on the UE side, there is a solution where the UE applies cellReselectionPriority included in the SIB when the UE does not receive the NSAG priority from the AMF and the dedicated signaling includes only nsag-CellReselectionPriority. However, this solution may waste radio resources and decrease the controllability on the NW side.

Observation 5: As a solution on the UE side when the UE does not receive the NSAG priority from the AMF and the dedicated signaling includes only nsag-CellReselectionPriority, the UE applies cellReselectionPriority included in the SIB.

### 2.2. Proposal

In light of the above discussion, when the UE does not receive the NSAG priority from the AMF and the dedicated signaling includes only nsag-CellReselectionPriority, handling for solutions on both the gNB side and the UE side is considered.

A case where the UE does not receive the NSAG priority from the AMF means that slice specific cell reselection is not allowed by the AMF. Accordingly, nsag-CellReselectionPriority in the dedicated signaling is not applied. In this case, the UE may apply cellReselectionPriority configured through the dedicated signaling or SIB.

Furthermore, not because the UE does not have a function for the slice specific cell reselection but because the UE is not allowed to use the slice specific cell reselection by the AMF, RAN2 should define this solution. On the other hand, the gNB recognizes a UE function for the slice specific cell reselection by checking UEcapability signaling, but does not recognize whether the AMF has configured the UE with the NSAG priority. Thus, the gNB may configure only nsag-CellReselectionPriority in the dedicated signaling. When the UE does not receive the NSAG priority from the AMF and the dedicated signaling includes only nsag-CellReselectionPriority, the current specifications may cause confusion in UE implementation.

Although three solutions (i.e., Observation 3 (O-3), Observation 4 (O-4), and Observation 5 (O-5)) have been discussed in this document, every solution has some problems.

O-4 is initially excluded because O-4 may affect RAN3 and RAN2 and collection is currently performed.

Both of the O-3 and O-5 solutions waste signal resources. For O-3, the operation of the gNB is affected. For O-5, the controllability on the NW side may decrease, which affects UE implementation.

Tentatively, the problem in which the UE does not receive the NSAG priority from the AMF and the dedicated signaling includes only nsag-CellReselectionPriority may be a rare case. Thus, when O-5 is considered as a last fail-safe rule, O-5 has less overall impact. O-5 is thus employed.

In conclusion, as a fail-safe rule, the solution of “Observation 5” with the least impact on specifications and implementation is desirable.

Proposal 2: When the UE does not receive the NSAG priority from the AMF and the dedicated signaling includes only nsag-CellReselectionPriority, the UE needs to apply the legacy frequency priority included in the SIB.

### 2.3. Proposal Sentence

If Proposal 2 above is agreed, the following proposal sentence of TS38.304 is proposed.

Proposal 3: RAN2 should agree on the proposal sentence in TS38.304 above.

### 5.2.4 Cell Reselection Evaluation Process

### 5.2.4.1 Reselection Priorities Handling

Absolute priorities of different NR frequencies or inter-RAT frequencies may be provided to the UE in the system information, in the RRC release message, or by inheriting from another RAT at inter-RAT cell (re) selection. In the case of system information, an NR frequency or inter-RAT frequency may be listed without providing a priority (i.e. no cellReselectionPriority field is present for that frequency). If cellReselectionPriority or nsag-CellReselectionPriority is provided in dedicated signaling, or if nsag-CellReselectionPriority is provided in dedicated signaling and NSAG priority information is provided in NAS, the UE shall ignore any fields with cellReselectionPriority and nsag-CellReselectionPriority provided in system information.

When UE is in camped normally state, if it supports slice-based cell reselection and has received NSAG and the priority thereof from NAS, UE shall derive reselection priorities according to clause 5.2.4.11.

1. A communication control method in a mobile communication system, the communication control method comprising:
by a user equipment, ignoring slice specific frequency priority information when the user equipment receives an RRC release message from a network node without receiving slice priority information from a core network apparatus, the slice priority information indicating a priority of a network slice, the RRC release message not comprising legacy frequency priority information and comprising the slice specific frequency priority information, the legacy frequency priority information indicating a priority per frequency, the slice specific frequency priority information indicating a priority of a frequency supporting the network slice.

2. The communication control method according to claim 1, wherein
the ignoring comprises, by the user equipment, performing a legacy cell reselection procedure by using the legacy frequency priority information when the user equipment receives, from the network node, a system information block comprising the legacy frequency priority information.

3. The communication control method according to claim 1, further comprising:
by the user equipment to the network node, transmitting an RRC message comprising information indicating that the slice specific frequency priority information has been ignored.

4. A user equipment comprising:
a controller configured to, ignore slice specific frequency priority information when the user equipment receives an RRC release message from a network node without receiving slice priority information from a core network apparatus, the slice priority information indicating a priority of a network slice, the RRC release message not comprising legacy frequency priority information and comprising the slice specific frequency priority information, the legacy frequency priority information indicating a priority per frequency, the slice specific frequency priority information indicating a priority of a frequency supporting the network slice.
